(19) United States
(12) Patent Application Publication
(10) Pub. No.: US 2018/0333931 A1
(43) Pub. Date: Nov. 22, 2018

(54) LVT Formulation for Achieving Drum Tack While Maintaining Good Cut Smoothness

(71) Applicant: AFI Licensing LLC, Lancaster, PA (US)

(72) Inventors: Raymond H. Miller, Marietta, PA (US); John R Eshbach, Marietta, PA (US); Elizabeth A Malkowski, Lancaster, PA (US); Kean M. Anspach, Quarryville, PA (US)

(73) Assignee: AFI Licensing LLC, Lancaster, PA (US)

(21) Appl. No.: 15/776,684

(22) PCT Filed: Nov. 16, 2016
(86) PCT No.: PCT/US16/62132

§ 371 Date: May 16, 2018

Related U.S. Application Data
(60) Provisional application No. 62/255,952, filed on Nov. 16, 2015.

(51) Int. Cl. B29D 99/00; B32B 3/30; B32B 37/00; B32B 37/24; E04F 15/10

(52) U.S. Cl. CPC B29D 99/0057; B32B 3/30; B32B 37/0053; B32B 37/24; E04F 15/105; B32B 2309/14; B32B 2419/04; B32B 2037/243; B32B 2309/02; B32B 2309/10; E04F 15/107

(57) ABSTRACT

Described herein is a floor panel comprising a base layer comprising: a binder, and a filler having a particle size distribution such that about 6 wt. % to 80 wt. % by weight of the filler passing through a 200 mesh screen.

### BACKGROUND

Flooring systems constructed of vinyl and other materials are known in the art. Flooring systems constructed of a number of flooring panels—specifically vinyl panels—are known as luxury vinyl tile, or LVT. Flooring systems generally have a decorative pattern on the visible surface to provide an aesthetically pleasing appearance. Previously, vinyl panels were formulated with base layer comprising binder and filler, wherein the filler has very fine particle sizes. However, such filler particle sizes result in inadequate drum tack during processing, thereby causing the base layer to slip relative to the processing equipment. Such slippage not only slows production but can also degrade the aesthetic appearance of each flooring panel as decorative features from one layer may not match up with topographical features provided to a subsequent layer. Thus, there exists a need for flooring panels that exhibit enhanced drum tack during processing while not sacrificing the other desirable properties of the flooring panel, such as shrinkage and edge smoothness.

### BRIEF SUMMARY

In one aspect, the invention may be a floor panel comprising: a base layer comprising: a binder; and a filler having a particle size distribution such that about 6 wt. % to 80 wt. % by weight of the filler passing through a 200 mesh screen.

In another aspect, the present invention may be a method of forming a floor panel comprising forming a base sheet from a binder and a filler having a particle size distribution such that about 6 wt. % to about 80 wt. % of the filler passes through a 200 mesh screen; bringing the base sheet into contact with an outer surface of a rotating drum, the base sheet adhering to the rotating drum, the outer surface of the rotating drum having an average surface roughness greater than 8 microinches; and feeding the base sheet through one or more process stations while the base sheet remains adhered to the outer surface of the rotating drum, thereby forming a laminate sheet.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top perspective view of a floor panel according to the present invention.

FIG. 2 is a cross-sectional view of the floor panel along the line II-II of FIG. 1.

FIG. 3 is a schematic illustration of a system used to form a floor panel according to an embodiment of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material. For the purposes of the present invention, the term “about” means+/−3% of the referred to amount.

The present invention is directed to a flooring panel, which can be installed in a system. The present invention further includes a method for making the flooring panel. The flooring panel comprising may comprise one or more layers—including a base layer. A plurality of the flooring panels may be installed in a room environment to create a flooring system, wherein at least two of the flooring panels are positioned adjacent to each other.

The flooring panel of the present invention may be a Luxury Vinyl Tile (“LVT”), a Vinyl Composition Floor Tile (“VCT”), or a Solid Vinyl Floor Tile (“SVT”). According to the present invention, “luxury vinyl tile” is an understood term of art in the flooring industry. According to ASTM F 1066, “Vinyl Composition Floor Tile” (VCT) is an accepted official standard category for flooring materials within the flooring industry. Similarly, according to ASTM F 1066, “Solid Vinyl Floor Tile” (SVT) is an accepted official standard category for flooring materials within the flooring industry.

Referring now to FIGS. 1-2 concurrently, the flooring panel 1 according to the present invention is illustrated. The flooring panel 1 comprises an uppermost exposed surface 3 and a lowermost exposed surface 2 that is opposite the uppermost exposed surface 3. In the exemplified embodiment, the flooring panel 1 comprises a plurality of layers that are laminated together. The plurality of layers may include, but are not limited to, a base layer 10, a print layer 20, a wear layer 30, and a top-film layer 40.

The base layer 10 comprises an upper base surface 12 and a lower base surface 11 that is opposite the upper base surface 12. The print layer 20 comprises an upper print surface 22 and a lower print surface 21 that is opposite the upper print surface 22. The wear layer 30 comprises an upper wear surface 32 and a lower wear surface 31 that is opposite the upper wear surface 32. The top-film layer 40 comprises an upper top-film surface 42 and a lower top-film surface 41 that is opposite the upper top-film surface 42.

In some embodiments, the print layer 20 may be laminated directly on the base layer 10 such that the upper base surface 12 of the base layer 10 contacts the lower print surface 21 of the print layer 20. In some embodiments, the wear layer 30 may be laminated directly on the print layer 20 such that the lower wear surface 31 contacts the upper print surface 22 of the print layer 20. In some embodiments, the print layer 20 may be omitted from the flooring panel 1 and the wear layer 30 may be laminated directly on the base layer 10 such that the lower wear surface 31 contacts the upper base surface 12 of the base layer 12 (not pictured). In some embodiments, the top-film layer 40 may be directly laminated on the wear layer 30 such that the lower top-film surface 41 of the top-film 40 contacts the upper wear surface 32 of the wear layer 30.

As best shown in FIG. 2, the lowermost exposed surface 2 of the flooring panel 1 comprises the lower base surface 11 of the base layer 10 while the uppermost exposed surface 3 of the flooring panel 1 comprises the upper top-film surface 42 of the top-film layer 40. In certain other embodiments, the top-film layer 40 may be omitted from the flooring panel and uppermost exposed surface 3 of the flooring panel 1 may comprise the upper wear surface 32 of the wear layer 30 (not pictured). Additionally, the uppermost exposed surface 3 of the flooring panel 1 may comprise embossed features 5.

In certain embodiments, the top-film layer 40 comprises vinyl polymer, such as polyvinyl chloride (PVC) or polyvinylidene chloride (PVDC). The top-film layer 40 may be a rigid vinyl film (RVF) having a top-film thickness measured from the upper top-film surface 42 to the lower top-film surface 41. The top-film thickness, in certain embodiments, ranges from about 3 mils to about 10 mils—including all sub-ranges and values there-between.

In certain embodiments, the wear layer 30 comprises a polymer and an abrasion resistant particle. Non-limiting examples of polymer include vinyl-polymer, acrylic polymer, and combination thereof. Non-limiting examples of vinyl-polymer include PVC, PVDC, or a combination thereof. Non-limiting examples of acrylic polymer include PMMA. Non-limiting examples of abrasion resistant particles may comprise silica, alumina, quartz, glass, silicon carbide, and a combination thereof. The wear layer 30 may further comprise a plasticizer—including, but not limited to, phthalate ester plasticizers.

In the exemplified embodiment, the wear layer 30 is a rigid vinyl film (RVF). The wear layer 30 has a wear thickness as measured from the upper wear surface 32 to the lower wear surface 31. The wear thickness is of at least 3 mils or more to provide a durable and long lasting wear layer for protecting the base layer 10. The wear thickness, in certain embodiments, may range from about 5 mils to about 40 mils, preferably from about 6 mils to about 20 mils —including all values and sub-ranges there-between. Exemplary embodiments may have a desired RVF thickness of about 20-40 mils which are suitable for LVT commercial application to provide satisfactory wear resistance performance to withstand heavy foot and other traffic. In one embodiment, a 20 mil RVF wear layer 30 may be used.

Semi-rigid vinyl films (Semi-RVF), which film composition contains a plasticizer, may also be used in the present process. Utilizing a semi-RVF may require additional post-product annealing steps to impart proper dimensional stability to the flooring panel 1.

The print layer 20 may be a rigid or semi-rigid PVC or a cellulosic substrate with ink printed on the upper print surface 20 of the print layer 20, thereby forming a decorative pattern. The print layer 20 has a print thickness ranging from about 1 μm (micron) to about 5 μm—including all values and sub-ranges there-between. The decorative pattern may include marks that resemble wood grain, stone, or the like.

The base layer 10 has a base thickness as measured from the upper base surface 12 to the lower base surface 11. The base thickness, in certain embodiments, ranges from about 60 mils to about 180 mils—including all sub-ranges and values there-between. The base layer 10 may comprise of a binder and filler, and optionally a plasticizer.

The binder may include polymer, such as vinyl polymer. Non-limiting examples of vinyl polymer include polyvinyl chloride (PVC), polyvinylidene chloride (PVDC), and combinations thereof. The polymer may be a low molecular weight polymer, having a K value ranging from about 56 to about 58—including all values and sub-ranges there-between. K value being an empirical parameter closely rehated to intrinsic viscosity based estimate of statistical molecular mass of polymeric material—particularly PVC. The polymer may comprise a medium molecular weight polymer having a K value of about 65 to about 67.

The plasticizer may comprise one or more phthalate ester compounds, phosphoric acid derivatives, esters of sebacic acid, glycolates, glycol derivatives of benzoic acid, epoxidized soybean oil fatty acids, chlorinated paraffin, partially-hydrogenated terphenyls, and esters of adipic acid.

Non-limiting examples of phthalate esters include dibutyl phthalate, dihexyl phthalate, dioctyl phthalate, diisooctyl phthalate, di-Z-ethylhexyl phthalate, dinonyl phthalate, diisodecyl phthalate, dicapryl phthalate, butyl octyl phthalate, butyl cyclohexylphthalate, butyl benzyl phthalate—as well as the corresponding isomers of terephthalate and isophthalate. Non-limiting examples of phosphoric acid derivatives include tricresyl phosphate, triphenyl phosphate, 2-ethylhexyl diphenyl phosphate. Non-limiting examples of esters of sebacic acid include dibutyl sebacate and di-Z-ethylhexyl sebacate. Non-limiting examples of glycolates include methyl phthalyl methyl glycolate, ethyl phthalyl ethyl glycolate, butyl phthalyl butyl glycolate, dibenzyl diglycolate. Non-limiting examples of glycol derivatives of benzoic acid include diethylene glycol dibenzoate and dipropylene glycol dibenzoate.

The filler may comprise organic material, inorganic material, and combination thereof. Specifically, the organic material may comprise organic fibers, organic particulates, and a combination thereof. The inorganic filler may comprise inorganic fibers, inorganic particulates, and a combination thereof.

The base layer may comprise about 20 wt. % to about 40 wt. % of binder—including all sub-ranges and values there-between. The base layer may comprise about 30 wt. % to about 80 wt. % of filler—including all sub-ranges and values there-between. The base layer may further comprise plasticizer in an amount ranging from about 20 wt. % to about 40 wt. % based on the total weight of the binder—including all sub-ranges and values there-between. Stated otherwise, the binder and plasticizer may be present in the base layer in a weight ratio that ranges from about 4:1 to about 2.5:1.

In certain embodiments, the base layer comprises about binder in an amount ranging from 22 wt. % to about 37 wt. % based on the total weight of the base layer, about 50 wt. % to about 77 wt. % of filler base on the total weight of the base layer, and plasticizer in an amount ranging from about 22 wt. % to 35 wt. % based on the total weight of the binder—including all values and sub-ranges there-between. In a preferred embodiment, the base layer comprises binder in an amount ranging from about 25 wt. % to about 35 wt. % based on the total weight of the base layer, filler in an amount ranging from about 65 wt. % to about 75 wt. % based on the total weight of the base layer, and plasticizer in an amount ranging from about 25 wt. % to about 30 wt. % based on the total weight of the binder—including all values and sub-ranges there-between.

Non-limiting examples of organic filler includes micro-fibers of various widths. As used herein, the term “micro-fiber” refers to any fiber having a dimension that is on the order of micrometers (10 meters). In some embodiments, the micro-fibers have a diameter of less than about 1500 micrometers, a diameter of less than about 100 micrometers, a diameter of less than about 50 micrometers, a diameter of less than about 10 micrometers, a diameter range of about 10 micrometers to about 1500 micrometers, a diameter range of about 10 micrometers to about 1000 micrometers, a diameter range of about 20 micrometers to about 500 micrometers, a diameter range of about 50 micrometers to about 500 micrometers, a diameter range of about 100 micrometers to about 500 micrometers, a diameter range of about 20 micrometers to about 400 micrometers, or a diameter range of about 40 micrometers to about 200 micrometers—including all values and sub-ranges there-between. The organic filler may be present in the base layer in an amount ranging from 0 wt. % to about 20 wt. % —including all sub-ranges and values there-between.

According to some embodiments, the inorganic filler of the present invention comprises a particulate having a particle size distribution. The particle size distribution may be represented by the amount of inorganic filler than passes through standard US mesh screens. Mesh screening is an accepted official standard for quantifying the size distribution of particles in a filler mixture.

Mesh screening is performed by passing filler through one or more mesh screens starting with a relatively more porous screens (i.e. 30, 40, 50) and continually passing the filler through decreasingly less porous screens (i.e., 100, 200, 325, 400). Each screen has a predetermined pore size that will block particles from passing through the screen if those particles have a size that is greater than the size of the screen pore. The following table demonstrates the pore size (in microns) of typical US mesh screens.

| US Mesh Size | Pore Size (μm) |
|---|---|
| 30 | 595-600 |
| 40 | 420-425 |
| 50 | 297-300 |
| 70 | 210-212 |
| 100 | 149-150 |
| 200 | 74 |
| 325 | 44 |
| 400 | 37 |

For example, if 100% of bulk filler passes through a 30 mesh screen, 100% of the bulk filler would have a particle size of less than about 600 microns (i.e., a 30 mesh screen has a pore size of about 600 microns). In another example, if 80% of bulk filler that passes through a 50 mesh screen, 20% of the bulk filler would have a particle size greater than or equal to 300 microns and 80% of the bulk filler would have a particle size less than about 300 microns (i.e., a 50 mesh screen has a pore size of about 300 microns).

According to the present invention, 100 wt. % of the inorganic filler has a particle size that is less than about 600 microns (i.e., 100 wt. % of the inorganic filler passes through a 30 mesh screen). According to the present invention, 100 wt. % of the inorganic filler has a particle size that is less than about 425 microns (i.e., 100 wt. % of the inorganic filler passes through a 40 mesh screen). According to the present invention, about 96 wt. % to about 100 wt. % of the inorganic filler has a particle size that is less than about 300 microns (i.e., about 96 wt. % to about 100 wt. % of the inorganic filler passes through a 50 mesh screen—including all values and sub-ranges there-between).

The inorganic filler of the present invention may comprise about 50 wt. % to about 99.8 wt. % (including all values and sub-ranges there-between) of particles having a particle size less than about 210 microns (i.e., about 50 wt. % to about 99.0 wt. % of the inorganic filler passes through a 70 mesh screen—including all values and sub-ranges there-between) as well as about 0.02 wt. % to about 50 wt. % (including all values and sub-ranges there-between) of particles having a particle size greater than or equal to about 210 microns (i.e., about 0.02 wt. % to about 50 wt. % of the inorganic filler passes that does not pass through a 70 mesh screen.

In certain embodiments, the inorganic filler of the present invention comprises about 30 wt. % to about 95 wt. % (including all sub-ranges there-between) of particles having a particle size less than about 150 microns (i.e., about 30 wt. % to about 95 wt. % of the inorganic filler passes through a 100 mesh screen—including all values and sub-ranges there-between) as well as about 5 wt. % to about 70 wt. % (including all values and sub-ranges there-between) of particles having a particle size greater than or equal to 150 microns (i.e. about 5 wt. % to about 70 wt. % of inorganic filler that does not pass through a 100 mesh screen).

In some embodiments, less than 90 wt. % of the inorganic filler passes through the 100 mesh screen and more than 80 wt. % of the inorganic filler passes through the 100 mesh screen. In other embodiments, less than about 80 wt. % of the inorganic filler passes through the 100 mesh screen and more than 30 wt. % of the inorganic filler passes through the 100 mesh screen.

According to the present invention, the inorganic filler comprises about 6 wt. % to 65 wt. % (including all sub-ranges there-between) of particles having a size of 74 microns or less (i.e., about 6 wt. 9% to about 65 wt. % of the inorganic filler passes through a 200 mesh screen) as well as about 35 wt. % to about 94 wt. % (including all sub-ranges there-between) of particles having a size greater than 74 microns (i.e., about 35 wt. % to about 94 wt. % of the inorganic filler does not pass through the 200 mesh screen).

In some embodiments, the inorganic filler comprises about 46 wt. % to about 65 wt. % (including all sub-ranges there-between) of particle having a size of 74 microns or less (i.e., about 46 wt. % to about 65 wt. % of the inorganic filler passes through a 200 mesh screen) and about 35 wt. 9% to about 54 wt. % (including all sub-ranges there-between) of particles having a size greater than 74 microns. In other embodiments, the inorganic filler comprises about 6 wt. % to about 40 wt. % (including all sub-ranges there-between) of particle having a size of 74 microns or less (i.e., about 6 wt. % to about 40 wt. % of the inorganic filler passes through a 200 mesh screen) and about 60 wt. % to about 94 wt. % (including all sub-ranges there-between) of particles having a size greater than 74 microns.

According to the present invention, less than about 25 wt. % of the inorganic filler has a particle size less of 44 microns of less (i.e., less than about 25 wt. % of the inorganic filler passes through a 325 mesh screen). Stated otherwise, more than about 75 wt. % of the inorganic filler has a particle size of 44 microns or greater. In a preferred embodiment, less than about 20 wt. % of the inorganic filler has a particle size of 44 microns or less (i.e., less than about 20 wt. % of the inorganic filler passes through a 325 mesh screen). Stated otherwise, more than about 80 wt. % of the inorganic filler has a particle size of 44 microns or greater. In a preferred embodiment, less than about 20 wt. % of the inorganic filler has a particle size of 44 microns or less (i.e., less than about 20 wt. % of the inorganic filler passes through a 325 mesh screen). Stated otherwise, more than about 80 wt. % of the inorganic filler has a particle size of 44 microns or greater.

Table 1 sets forth multiple non-limiting embodiments of the present invention (E1, E2, E3 . . . ) that demonstrate the amount (wt. %) of the inorganic filler that passed through various mesh screens.

TABLE 1

| | | E1 | E2 | E3 | E4 | E5 | E6 | E7 | E8 |
|---|---|---|---|---|---|---|---|---|---|
| 30 | Mesh | 100 | 100 | 100 | 100 | 100 | 100 | 100 | 100 |
| 40 | Mesh | 100 | 100 | 100 | 100 | 100 | 100 | 100 | 100 |
| 50 | Mesh | 96-100 | 96-100 | 96-100 | 96-100 | 100 | 96-100 | 96-100 | 96-100 |
| 70 | Mesh | 50-99 | 50-99 | 50-99 | 50-99 | 50-99 | 50-95 | 50-95 | 50-95 |
| 100 | Mesh | 30-95 | 30-95 | 35-90 | 30-77 | 70-90 | 80-90 | 30-77 | 35-70 |
| 200 | Mesh | 6-65 | 6-50 | 6-50 | 6-41 | 40-65 | 6-45 | 7-45 | 8-42 |
| 325 | Mesh | <25 | <25 | <25 | <25 | <25 | <25 | <20 | <20 |

In certain embodiments, the inorganic filler may comprise about 6 wt. % to about 90 wt. % (including all sub-ranges there-between) of particles having a particle size that is greater than about 74 microns and less than about 150 microns. In a preferred embodiment, the inorganic filler may comprise about 7 wt. % to about 77 wt. % of particles having a size that is greater than about 74 microns and less than about 150 microns.

Non-limiting examples of inorganic filler includes particles of calcium carbonate (“limestone”), magnesium carbonate, silica, talc, clay, and combinations thereof.

The base layer of the present invention may be produced by melt-mixing the binder, the filler, and optionally the plasticizer in an industrial mixer (e.g. banbury mixer) or melt-mixer (e.g. a single or twin screw extruder) to make a mixed composition. The filler can be added to the binder in the melt-mixer before, after, or simultaneously with the plasticizer. The mixed composition may then be fed to two or more calendering rolls, where the mixed composition is formed into a base sheet. The base sheet may then be further processed by a laminating system, which laminates one or more of a print sheet, wear sheet, and/or top-film sheet, thereby creating a laminate structure. The laminate structure is then cut to the final dimensions of the flooring panel 1 of the present invention, as described herein.

As described further herein, the specific particle size distribution of the filler results in flooring panels having superior edge smoothness after being cut to the final dimensions.

Additionally, the particle size distribution of the filler results in superior drum tack during processing in the laminating system. The superior drum tack helps avoid processing difficulties that occur when drum tack is broken during lamination—such as a laminate structure extruding back through the processing equipment in the laminating system 100.

Referring now to FIG. 3, the laminating system 100 of the present invention may be a drum laminating system—as compared to a conveyor type laminating system comprising one or more belts and a plurality of belt rollers, various printing, laminating, and embossing operations are performed at different locations spaced along the circumference of a large rotating drum.

Referring to FIG. 3, the laminating system 100 generally includes a rotating main process drum 120 (as referred to as the “drum”) and one or more process stations (also referred to as “laminating stations”) associated with the drum 120. The process stations are located about the drum 120 and are disposed at different circumferential locations spaced around the drum 120, as shown in FIG. 3. In certain other embodiments, the process stations may be located at the same circumferential location around the drum 120. The process stations of the present invention include a print layer application station 130, a wear layer application station 140, and an embossing station 150.

The drum 120 may be cylindrical with a diameter and a width that are suitable for handling the width of the base sheet 102 being processed and the process speeds of the laminate sheet 202. The drum 120 may rotate about a rotational axis (“A_{R}”). The drum 120 further comprises a circumferential outer surface 122 (also referred to as the “outer surface”).

The diameter of the drum 120 is measured to the outer surface 122 of the drum 120. The diameter of the drum 120 may be selected to provide adequate separation between the drum 120 and a roller 132, 142, 152 of each process station and to allow for adequate time for adhesion of the each subsequent layer laminated to the base layer, heating the laminate to appropriate temperatures during the laminating process, etc.

The drum 120 may have a first diameter ranging from about 30 cm to about 305 cm as measured from the outer surface 122 of the drum. In certain embodiments, the first diameter of the drum 120 ranges from about 30 cm to about 125 cm—including all sub-ranges and values there-between. In other embodiments, the first diameter of the drum 120 ranges from about 122 cm to about 305 cm—including all sub-ranges and values there-between.

It will be appreciated that other suitable diameters up to a practical limit of about 365 cm may be used depending on the linear velocity of the outer surface 122 of the rotating drum 120 and corresponding process time intervals necessary to properly complete the various floor covering product formation operations described herein.

The flooring panel 1 may be produced by first creating the base sheet 102. The base sheet 102 may be produced by mixing the binder, the filler, and optionally the plasticizer in a mixer (e.g. banbury mixer, single screw extruder, twin screw extruder) then calendering the mixture between at least two calendering rolls to create a base sheet 102 (not pictured). The base sheet 102 may then conveyed to the drum 120 by a mechanical carrier 110, such as a belt conveyor 110. The base sheet 102 may be conveyed by the mechanical carrier 110 at a speed ranging from about 15 M/min (meters per minute) to about 35 M/min—including all sub-ranges and values there-between.

The belt conveyor 110 brings the base sheet 102 into contact with the outer surface 122 of the drum 120 at a first point P₁ where the base sheet 102 adheres to the outer surface 122 of the drum 120. As the drum 120 rotates about the rotational axis A_{R}, the base sheet 102 is carried about the outer drum surface 122 and eventually fed through one or more of the process station 130, 140, 150, thereby eventually forming a laminate sheet 202. The base sheet 102 may be carried about the outer drum surface 122 and fed through the process station 130, 140, 150, in a continuous process. Having a single drum 120 that can continuously carry the base sheet 102 to each of the process stations 130, 140, 150 not only saves time, but also reduces the amount of space required for manufacturing equipment and energy required for all manufacturing equipment to run, thereby reducing cost.

The base sheet 102 may be any suitable thickness depending on the final floor covering product to be produced. The base sheet 102 may generally have a representative gauge or thickness ranging from about 60 mils to about 220 mils—including all values and sub-ranges there-between. In a preferred embodiment, the base sheet 102 may have a thickness ranging from about 80 mils to about 160 mils for LVT products—including all values and sub-ranges there-between.

According to the present invention, the drum 120 has an outer surface 122 with an average roughness (RA) that is greater than 8 microinches, which, when used in combination with the base layer 102 of the present invention, results in good-to-great drum tack of the lower surface 102b of the base layer 102 on the outer surface 122 of the drum 120 during processing. Ensuring that the lower surface 102b of the base layer 102 remains adhered to the outer surface 122 of the drum 120 prevents unwanted slippage and back-extrusion as the base layer 102 is fed through one or more of the process stations 130, 140, 150, thereby providing in a superior final flooring panel.

In certain embodiments, the outer drum surface 122 has an average roughness greater than 16 microinches, alternatively from about 20 microinches to about 80 microinches; alternatively about 25 microinches to about 75 microinches—including all sub-ranges and values there-between. In a preferred embodiment, the average surface roughness of the outer surface 122 of the drum 120 ranges from about 32 microinches to about 64 microinches—including all sub-ranges and values there-between. In certain embodiments, the average surface roughness of the outer surface 122 of the drum 120 is 32 microinches. In certain embodiments, the average surface roughness of the outer surface 122 of the drum 120 is 64 microinches.

As shown in FIG. 3, after the base sheet 102 contacts the outer surface 122 of the drum 120 at point P₁, the base sheet 102 may be fed through a print layer application station 130. As the base sheet 102 is fed through the print layer application station 130, the base sheet 102 and a print sheet 136 are passed between the drum 120 and a print roller 132 such that the print sheet 136 is laminated to an upper surface 102a of the base sheet 102 by heat and pressure to form a base-print sheet laminate 200. As the base sheet 102 is fed through the print layer application station 130, the base sheet 102 remains adhered to the outer surface 122 of the rotating drum 120. Specifically, during the lamination of the print sheet 136, the lower surface 102b of the base sheet 102 remains adhered to the outer surface 122 of the drum 120.

The print roller 132 has a second diameter, wherein the first diameter of the drum 120 is greater than the second diameter of the print roller 132. The ratio of the first diameter to the second diameter may range from about 15:1 to about 2:1; alternatively from about 10:1 to about 5:1.

As further shown in FIG. 3, the base-print sheet laminate 200 may be fed to the wear layer application station 140 after leaving the print layer application station 130. When the base-print sheet laminate 200 is fed through the wear layer application station 140, the base-print sheet laminate 200 and the wear sheet 146 are passed between the drum 120 and a wear roller 142 such that the wear sheet 146 is laminated (by heat and pressure) to an upper surface 136a of the print sheet 136 portion of the base-print sheet laminate 200 to form a base-print-wear sheet laminate 201. As the base-print sheet laminate 200 is fed through the wear layer application station 140, the base sheet 102 portion of the base-print sheet laminate 200 remains adhered to the outer surface 122 of the rotating drum 120. Specifically, during the lamination of the wear sheet 146 to the base-print sheet laminate 200, the lower surface 102b of the base sheet 102 portion of the base-print sheet laminate 200 remains adhered to the outer surface 122 of the drum 120.

The wear roller 142 has a third diameter, wherein the first diameter is greater than the third diameter. The ratio of the first diameter to the third diameter ranges from about 15:1 to about 2:1; alternatively from about 10:1 to about 5:1.

In certain embodiments, the system 100 may omit the print layer application station 130 and the base sheet 102 may be fed directly to the wear layer application station 140 where the base sheet 102 and the wear sheet 146 are passed between the drum 120 and the wear roller 142. In such embodiments, the wear sheet 146 is laminated to the upper surface 102a of the base sheet 102 by heat and pressure to form a base-wear sheet laminate (not pictured). As the base sheet 102 is fed through the wear layer application station 140, the base sheet 102 remains adhered to the outer surface 122 of the rotating drum 120. Specifically, during the lamination of the wear sheet 146 to the base layer 102, the lower surface 102b of the base sheet 102 remains adhered to the outer surface 122 of the drum 120.

As demonstrated in FIG. 3, after leaving the wear layer application station 140, the base-print-wear sheet laminate 201 remains adhered to the outer surface 122 of the drum 120 (i.e., the lower surface 102b of the base-print-wear sheet laminate 201 remains adhered to the outer surface 122 of the drum 120). The base-print-wear sheet laminate 201 is then fed to an embossing station 150 where the base-print-wear sheet laminate 201 is passed between the drum 120 and an embossing roller 152 that imprints embossed features 5 onto an upper surface 146a of the wear layer 146 portion of the base-print-wear sheet laminate 201—thereby forming the laminate structure 202. As shown in FIGS. 1-2, the embossed features 5 may include elongated grooves, pores, slits, waves, streaks, cathedrals, and other shapes that emphasize the printed pattern. Referring to FIG. 3, as the base-print-wear sheet laminate 201 is fed through the embossing station 150, the base sheet 102 remains adhered to the outer surface 122 of the rotating drum 120. Specifically, during embossing, the lower surface 102b of the base sheet 102 portion of the base-print-wear sheet laminate 201 remains adhered to the outer surface 122 of the drum 120.

The base-print-wear sheet laminate 201 may be heated by heaters 300 to an elevated temperature prior to embossing so that the embossing temperature in one embodiment is higher than the preheat temperature of the wear layer sheet 146 at the wear layer laminating station 140. It has been discovered that heating the base-print-wear sheet laminate 201 prior to the embossing is beneficial with thicker wear layer sheets 146 (i.e. 12 mils or higher) to achieve proper depth and definition of the embossed surface features in the laminate structure 202.

In certain embodiments, a third lamination step may be additionally performed at embossing station 150 to add pre-embossed, pre-coated, and/or other top-film sheet 176 onto the wear sheet 146 from a bolt or roll 170 prior to, during, or instead of embossing. If a pre-embossed film or sheet is added, a roller with a smooth outer surface finish in lieu of an embossing roller 152 having an undulating outer surface with the reverse image of the embossing pattern formed thereon may be used.

For the embodiments that include the top-film sheet 176, the base-print-wear sheet laminate 201 and the top-film sheet 176 may be fed through the embossing station 150 causing the base-print-wear sheet laminate 201 and the top-film sheet 176 to be passed between the drum 120 and the embossing roller 152 thereby laminating the top-film sheet 176 (by heat and pressure) to the upper surface 146a of the wear sheet 146 portion of the base-print-wear sheet laminate 201 and forming the laminate structure 202. As the base-print-wear sheet laminate 201 and the top-film sheet 176 are fed through the embossing station 150, the base sheet 102 portion remains adhered to the outer surface 122 of the rotating drum 120. Specifically, during the lamination of the top-film sheet 176 to the base-print-wear sheet laminate 201, the lower surface 102b of the base sheet 102 remains adhered to the outer surface 122 of the drum 120.

The particle size distribution of the filler in the base layer 102 as well as the average surface roughness of the outer surface 122 of the drum 120 ensures proper drum tack between the base layer 102 and the drum 120 during the lamination stages in each application station 130, 140, 150. Although relevant to each lamination station, 130, 140, 150, the drum tack has been discovered to be particularly useful during embossing. For laminate structures 202 comprising the print layer 102, the embossed features 5 may match or correspond to the decorative pattern present on the print layer 136. Thus, providing adequate drum tack prevents the base layer 102 from slipping relative to the drum 120, thereby ensuring that the embossed features 5 not only have the correct placement relative to the decorative features on the print layer 130, but also help ensure that the embosses features 5 have the correct dimensions—i.e. are not elongated due to the base layer not pass about the drum at a proper speed relative to the embossing roller 152.

As shown in FIG. 3, after embossing is completed the laminate sheet 202 continues on process drum 120 to a release point P2 associated with a release roller 162 where the laminate sheet 202 is removed from the drum 120. The laminate sheet 202 may then be fed into a cutting station (not pictured), where the laminate sheet 202 is cut in a plurality of floor panels 1.

The drum 120 may formed of a material that is operable to provide temperature controlled adherence and release of a base layer sheet 102 based on hot stick adherence and cold release principles, as will be well known to those skilled in the art. Vinyl-based products exhibit such characteristics and facilitates adherence of the base sheet 102 to drum 120 for processing and lamination. In certain embodiments, the drum 120 may be made of steel and the outer surface 122 may be chrome plated to provide a smooth surface.

The drum 120 may be operated such that the outer surface 122 of the drum 120 has a temperature ranging from about 75° C. to about 135° C.; alternatively about from 80° C. to about 125° C.—including all sub-ranges and values there-between. In a preferred embodiment, the drum 120 is operated such that the outer surface 122 of the drum 120 has a temperature ranging from about 95° C. to about 115° C.—including all sub-ranges and values there-between.

In other embodiments of the present invention, the print laminating station 130 and wear layer laminating station 140 operations may be combined into a single laminating station instead of being performed separately on drum 120. Accordingly, laminating station 140 may preheat the wear layer 146 and then combine and laminate the wear layer 146 and print layer 136 to base layer sheet 102 via laminating roller 142 in a single step. The feed of print layer 136 from supply roll 134 may be directed to roller 142 instead of roller 132 (see FIG. 3) and combined with wear layer 146 after heating the wear layer.

Since the laminate (i.e. base layer sheet 102) temporarily adheres to outer surface 122 of drum 120 via principles of hot stick adhesion and cold release for vinyl based products, the laminate must cooled sufficiently to a release temperature wherein the laminate sheet will no longer adhere to and separate from the drum. In one embodiment, the cooling is provided by a plurality of water sprays positioned proximate to drum 120 which spray water directly onto the laminate sheet 202. In addition, the water sprays rapidly cool the exposed surface of the wear sheet 146 below the glass transition temperature of its polymer, thereby imparting dimensional stability to the laminate sheet 202. The release temperature may vary depending on the composition of the base sheet 102 and thickness of the base sheet 102 and wear sheet 146.

In some embodiments, the flooring panel 1 of the present invention may further comprise one or more intervening layers between the base layer 10, print layer 20, wear layer 30, and the top-film layer 40. The flooring panel 1 of the present invention may have final dimensions that include an overall length ranging from about 12 inches to about 96 inches, an overall width ranging from about 2 inches to about 48 inches, and an overall thickness ranging from about 80 mils to about 200 mils—including all value and sub-ranges there-between.

The foregoing discussion further applies to building panels that may be used as ceiling panels and wall panels.

As those skilled in the art will appreciate, numerous changes and modifications may be made to the embodiments described herein, without departing from the spirit of the invention. It is intended that all such variations fall within the scope of the invention.

### EXAMPLES

The base layer of the following examples were prepared using the follow components:

Filler: limestone powder with trace (<5 wt. %) of silica and magnesium carbonate;

Binder: low molecular weight PVC resin, commercially available as Occidental 185;

Plasticizer: dioctyl terephthalate (DOTP);

Stabilizer: Baerlocher stabilizer; and

Pigment: black pigment.

Regarding the types of filler, seven different samples were created and their particle size distributions are set forth below in Table 2.

TABLE 2

| | | | | | Comp. | Comp. | Comp. |
|---|---|---|---|---|---|---|---|
| | Ex. 1 | Ex. 2 | Ex. 3 | Ex. 4 | Ex. 1 | Ex. 2 | Ex. 3 |
| 30 | 100% | 100% | 100% | 100% | 100% | 100% | 100% |
| 40 | 100% | 100% | 100% | 100% | 99% | 100% | 100% |
| 50 | 96% | 100% | >99% | 100% | 95% | 98.5% | 100% |
| 70 | 60% | — | — | 99.8 | 90% | 97.5% | 100% |
| 100 | 35% | 68% | 77% | 89.7% | 80% | 90% | 100% |
| 200 | 8% | 27% | 41% | 51% | 45% | 82.7% | 99% |
| 325 | 4% | — | 18% | 19.6% | 25% | 59.6% | 85% |

Each example is prepared by melt-mixing together the filler, binder, and plasticizer to form a mixed composition, and calendering the mixed composition between two calendering rolls to form a base sheet. The amount of filler, binder, and plasticizer for each example is set forth below in Table 3.

TABLE 3

| | | | | | Comp. | Comp. | Comp. |
|---|---|---|---|---|---|---|---|
| | Ex. 1 | Ex. 2 | Ex. 3 | Ex. 4 | Ex. 1 | Ex. 2 | Ex. 3 |
| Filler wt. % | 66 | 66 | 66 | 66 | 66 | 66 | 66 |
| Binder wt. % | 25.5 | 25.5 | 25.5 | 25.5 | 25.5 | 25.5 | 25.5 |
| Plasticizer | 8.5 | 8.5 | 8.5 | 8.5 | 8.5 | 8.5 | 8.5 |
| wt. % | | | | | | | |
| Total wt. % | 100 | 100 | 100 | 100 | 100 | 100 | 100 |
| Weight | 3:1 | 3:1 | 3:1 | 3:1 | 3:1 | 3:1 | 3:1 |
| Ratio of | | | | | | | |
| Binder to | | | | | | | |
| Plasticizer | | | | | | | |

The plasticizer is present in an amount of 8.5 wt. % based on the total weight of the base layer. The plasticizer is also present in an amount of 25 wt. % based on the total weight of the binder. Each base sheet was then contacted with three separate drums, each of which have a drum temperature of about 211° C. and a drum speed of about 9 M/min. The first drum has an average roughness (RA) of 8 microinches, the second drum has an average roughness (RA) of 32 microinches, and the third drum has an average roughness (RA) of 64 microinches. Each base layer was then separated from the drum and cut to the final dimensions of the flooring panel.

The drum tack of each base layer on the various drums set forth below in Table 4, wherein the drum tack ranges from 0 (worst) to 4 (best). For example, a value of 0 represents no drum tack whatsoever, as there is substantial slippage of the base layer on the drum during processing. Furthermore, the resulting laminate sheets are cut to the final dimensions and the edge cuts are evaluated for edge smoothness. Specifically, a visual assessment of each edge cut is performed, where the edge cuts without severe roughness or pitting from the filler are deemed to have a commercially acceptable edge cut (i.e. pass). The samples were designated pass or fail based on having both adequate drum tack as well as commercially acceptable edge cut.

TABLE 4

| | | | | | | Comp. | Comp. | Comp. |
|---|---|---|---|---|---|---|---|---|
| | | Ex. 1 | Ex. 2 | Ex. 3 | Ex. 4 | Ex. 1 | Ex. 2 | Ex. 3 |
| 30 | Mesh | 100% | 100% | 100% | 100% | 100% | 100% | 100% |
| 40 | Mesh | 100% | 100% | 100% | 100% | 99% | 100% | 100% |
| 50 | Mesh | 96% | 100% | >99% | 100% | 95% | 98.5% | 100% |
| 70 | Mesh | 60% | — | — | 99.8 | 90% | 97.5% | 100% |
| 100 | Mesh | 35% | 68% | 77% | 89.7% | 80% | 90% | 100% |
| 200 | Mesh | 8% | 27% | 41% | 51% | 45% | 82.7% | 99% |
| 325 | Mesh | 4% | — | 18% | 19.6% | 25% | 59.6% | 85% |

| | | | | | | | |
|---|---|---|---|---|---|---|---|
| Average Drum Tack (8 RA) | N/A | 4.0 | 4.0 | 2.5 | 3.8 | 0.0 | 0.0 |
| Average Drum Tack (32 RA) | N/A | 4.0 | 4.0 | 3.5 | 3.3 | 0.5 | 0.0 |
| Average Drum Tack (64 RA) | 4.0 | 4.0 | 4.0 | 4.0 | 3.5 | 2.5 | 0.0 |
| Adequate Drum Tack | Yes | Yes | Yes | Yes | Yes | No | No |
| Commercially Acceptable Edge Cut | Yes | Yes | Yes | Yes | No | Yes | Yes |
| Pass//Fail | Pass | Pass | Pass | Pass | Fail | Fail | Fail |

As shown in Table 1, Examples 1-4 have 96 wt. % to 100 wt. % of the filler pass through a 50 mesh screen, between 50 wt. % and 99.9 wt. % of the filler pass through a 70 mesh screen, 30 between 90 wt. % of the filler pass through a 100 mesh screen, 6 wt. % to 65 wt. % of the filler pass through a 200 mesh screen and less than 25 wt. % of the filler pass through a 325 mesh screen—thereby not only provide adequate drum tack on rollers having an average roughness greater than 8 microinches (preferably greater than 32 microinches) as well as having commercially acceptable edge cuts after being cut to the final dimensions.

The present invention is not limited by the foregoing discussion. The present invention may include variations and modifications to the embodiments discussed herein.

What is claimed is:

1. A floor panel comprising:
a base layer comprising:
a binder, and
a filler having a particle size distribution such that about 6 wt, % to 80 wt. % by weight of the filler passing through a 200 mesh screen.

2. The floor panel according to claim 1 wherein the particle size distribution is such that 100 wt. % of the filler passes through a 40 mesh screen.

3. The floor panel according to claim 2 wherein the particle size distribution is such that about 96 wt. % to about 100 wt. % of the filler passes through a 50 mesh screen.

4. The floor panel according to any one of claims 1 to 3 wherein the particle size distribution is such that greater than about 30 wt. % of the filler passes through a 100 mesh screen.

5. The floor panel according to claim 4 wherein the particle size distribution is such that less than about 95 wt. % of the filler passes through a 100 mesh screen.

6. The floor panel according to any one of claims 1 to 3 wherein the particle size distribution is such that less than about 80 wt. % of the filler passing through a 100 mesh screen.

7. The floor panel according to any one of claims 1 to 6 wherein the particle size distribution is such that less than about 25 wt. % of the filler passes through a 325 mesh screen.

8. The floor panel according to claim 1 wherein the particle size distribution is such that about 30 wt. % to about 90 wt. % of the filler passes through a 100 mesh screen, and less than 20 wt. % by weight of the filler passes through a 325 mesh screen.

9. The floor panel according to any one of claims 1 to 9 wherein binder comprises a vinyl polymer.

10. The floor panel according to any one of claims 1 to 10 wherein the filler is selected from a group consisting of calcium carbonate, magnesium carbonate, talc, barytes, silica, and combinations thereof.

11. The floor panel according to any one of claims 1 to 11 wherein the base layer further comprises a plasticizer.

12. The floor panel according to claim 11 wherein the base layer comprises:
the binder in an amount of about 20 wt. % to about 40 wt. % of the base layer;
the filler in an amount of about 30 wt % to about 80 wt. % of the base layer; and
the plasticizer, wherein the plasticizer is present in a weight ratio with the binder ranging from about 1:2.5 to about 1:4.

13. The floor panel according to any one of claims 1 to 12 further comprising a print layer on an upper surface of the base layer.

14. The floor panel according to any one of claims 1 to 13 wherein the floor panel comprises an uppermost exposed surface comprising embossed features.

15. The floor panel according to claim 14 further comprising a wear layer atop the print layer.

16. A method of forming a floor panel comprising:
a) forming a base sheet from a binder and a filler having a particle size distribution such that about 6 wt. % to about 80 wt. % of the filler passes through a 200 mesh screen;
b) bringing the base sheet into contact with an outer surface of a rotating drum, the base sheet adhering to the rotating drum, the outer surface of the rotating drum having an average surface roughness greater than 8 microinches; and
c) feeding the base sheet through one or more process stations while the base sheet remains adhered to the outer surface of the rotating drum, thereby forming a laminate sheet.

17. The method according to claim 16, wherein the outer surface of the rotating drum has an average surface roughness ranging from 25 microinches to 75 microinches.

18. The method according to any one of claims 16 to 17, wherein the base sheet passes through one or more process stations at a feed rate ranging from 10 meters per minute to 35 meters per minute.

19. The method according to any one of claims 16 to 18, wherein the drum is operated at a temperature ranging from 80° C. to 125° C.

20. The method according to any one of claims 16 to 19, wherein the drum has a diameter ranging from about 30 cm to about 125 cm.

21. The method according to any one of claims 16 to 19, wherein the drum has a diameter ranging from about 122 cm to about 305 cm.

22. The method according to any one of claims 16 to 21, wherein the particle size distribution is such that about 96 wt. % to about 100 wt. % of the filler passes through a 50 mesh screen.

23. The method according to any one of claims 16 to 22, wherein the particle size distribution is such that greater than about 30 wt. % of the filler passing through a 100 mesh screen.

24. The method according to any one of claims 16 to 23, wherein the particle size distribution is such that about 30 wt. % to 90 wt. % of the filler passing through a 100 mesh screen, and less than about 25 wt. % of the filler passing through a 325 mesh screen

25. The method according to any one of claims 16 to 24 wherein binder comprises a vinyl polymer and the filler is selected from a group consisting of calcium carbonate, magnesium carbonate, talc, barytes, silica, and combinations thereof.

26. The method according to anyone of claims 16 to 25, wherein step c) comprises:
c-1) feeding the base sheet through a print layer application station in which the base sheet and a print sheet are passed between the drum and a print roller such that the print sheet is laminated to the base sheet, the base sheet remaining adhered to the outer surface of the rotating drum during lamination of the print sheet to the base sheet.

27. The method according to claim 26, wherein the drum has a first diameter and the print roller has a second diameter, the first diameter being greater than the second diameter.

28. The method according to anyone of claims 16 to 25, wherein step c) comprises:
c-2) feeding the base sheet through a wear layer application station in which the base sheet and a wear sheet are passed between the drum and a wear roller such that the wear sheet is laminated to the base sheet, the base sheet remaining adhered to the outer surface of the rotating drum during lamination of the wear sheet to the base sheet.

29. The method according to claim 28, wherein the drum has a first diameter and the wear roller has a third diameter, the first diameter being greater than the third diameter.

30. The method according to anyone of claims 16 to 25, wherein step c) comprises:
c-3) feeding the base sheet through an embossing station in which the lamination sheet is passed between the drum and an embossing roller, the base sheet portion of the lamination sheet remaining adhered to the outer surface of the rotating drum during embossing.

31. The method according to claim 30, wherein the drum has a first diameter and the embossing roller has a fourth diameter, the first diameter being greater than the fourth diameter.

32. The method according to anyone of claims 32 to 31, wherein step c-3) further comprises:
laminating a top-film sheet at the embossing station in which a top-film sheet and the base layer are passed between the drum and a embossing roller such that the top-film sheet is laminated to the base sheet, the base sheet remaining adhered to the outer surface of the rotating drum during lamination of the top-film sheet to the base sheet.

33. The method according to any one of claims 16 to 32 wherein steps a) through c) are a continuous roll forming process

34. The method according to anyone of claims 16 to 25, wherein step c) comprises:
feeding the base sheet through a print layer application station in which the base sheet and a print sheet are passed between the drum and a print roller such that the print sheet is laminated to the base sheet to form a base-print sheet laminate, the base sheet remaining adhered to the outer surface of the rotating drum during lamination of the print sheet to the base sheet;
feeding the base-print sheet laminate through a wear layer application station in which the base-print sheet laminate and a wear sheet are passed between the drum and a wear roller such that the wear sheet is laminated to the base-print sheet laminate to form a base-print-wear sheet laminate, the base sheet of the base-print sheet laminate remaining adhered to the outer surface of the rotating drum during lamination of the wear sheet to the base-print sheet laminate;
feeding the base-print-wear sheet laminate through an embossing station in which the base-print-wear sheet laminate and a top-film sheet are passed between the drum and an embossing roller such that the top-film sheet is laminated to the base-print-wear sheet laminate to form a base-print-wear-top-film sheet laminate while having an embossing pattern imprinted by the embossing roller, and base sheet of the base-print-wear sheet laminate remaining adhered to the outer surface of the rotating drum during embossing and/or lamination of the top-film sheet to the base-print-wear sheet laminate.

35. The method according to any one of claims 16 to 34 further comprising:
d) removing the laminate sheet from the drum;
e) feeding the laminate sheet into a cutting station, thereby cutting laminate sheet into a plurality of floor panels.
